(19) United States
(12) Patent Application Publication
(10) Pub. No.: US 2022/0390631 A1
(43) Pub. Date: Dec. 8, 2022

(54) LAPLACE-FOURIER 1.5D FORWARD MODELING USING AN ADAPTIVE SAMPLING TECHNIQUE

(71) Applicant: Saudi Arabian Oil Company, Dhahran (SA)

(72) Inventors: Apostolos Kontakis, Delft (NL); Diego Rovetta, Delft (NL); Daniele Colombo, Dhahran (SA)

(21) Appl. No.: 17/335,571

(22) Filed: Jun. 1, 2021

(51) Int. Cl. G01V 1/28; G01V 1/30; G01V 1/32

(52) U.S. Cl. CPC G01V 1/282; G01V 1/303; G01V 1/32; G01V 2210/6222; G01V 2210/42

(57) ABSTRACT

An example method is for producing a seismic wave velocity model of a subsurface area. The method includes receiving, by a processor of a computing system, from a seismic receiver, seismic data input comprising a recorded seismic wave field. The method includes receiving, by the processor, an initial 1D velocity model of the subsurface area. The method includes determining, by the processor, a Laplace-Fourier transform of the recorded seismic wave field. The method includes regenerating, by the processor, the current 1D velocity model to generate inverted data representing the subsurface area. The method may include performing, by the processor, an upscaling of a plurality of 1D velocity models to produce a 3D velocity model.

### TECHNICAL FIELD

This specification describes technologies for computational modeling and seismic data processing.

### BACKGROUND

In data processing, for example, seismic data processing, computational modeling techniques including waveform inversion may be employed, for example, to generate a seismic velocity model of a subterranean (rock) formation based. The models may be based on certain characteristics of seismic signals. A technique that may be used for a high-resolution seismic imaging based the entire content of seismic traces is known as Full Waveform Inversion (FWI). FWI may be used for refining detailed seismic (acoustic) velocity fields in order to achieve improved subsurface images.

### SUMMARY

An example method is for producing a seismic wave velocity model of a subsurface area. The method includes receiving, by a processor of a computing system, from a seismic receiver, seismic data input comprising a recorded seismic wave field. The method includes receiving, by the processor, an initial 1D velocity model of the subsurface area. The method includes receiving, by the processor, data input comprising a maximum misfit value and maximum iteration value. The method includes determining, by the processor, a Laplace-Fourier transform of the recorded seismic wave field.

The method includes setting, by the processor, a current 1D velocity model to the initial 1D velocity model. The method includes setting, by the processor, an iteration value n to zero. The method includes regenerating, by the processor, the current 1D velocity model to generate inverted data representing the subsurface area.

The method includes generating, by the processor, a modeled synthetic wave field in the Laplace-Fourier domain using the current 1D velocity model (step (i)). The method includes comparing the modeled synthetic wave field with the recorded seismic wave field to determine a misfit value (step (ii)). The method includes if the determined misfit value is less than the maximum misfit value, outputting the current 1D velocity model as the final 1D velocity model (step (iii)). The method includes if the determined misfit value is greater than the maximum misfit value, and if the iteration value is equal to or greater than the maximum iteration value, outputting the current 1D velocity model as the final velocity model (step (iv)). The method includes, if the determined misfit value is greater than the maximum misfit value, and if the iteration value is less than the maximum iteration value, generating a corrected current 1D velocity model using a gradient of a misfit function and setting the iteration value to n+1 (step (v)). The method includes repeating steps (i) through (v).

The method may include performing, by the processor, an upscaling of a plurality of 1D velocity models to produce a 3D velocity model.

Generating a modeled synthetic wave field in the Laplace-Fourier domain may include calculating an inverse Hankel transformation integral using an iterative horizontal wavenumber line segmentation process to determine locations for sampling the integrand and the upper limit at which to truncate the transformation integral. The segmentation process may include determining an end to a segment using the Newton-Raphson method.

Generating a modeled synthetic wave field in the Laplace-Fourier domain may include calculating an inverse Hankel transformation using an adaptive sampling technique to determine horizontal wavenumbers to be sampled in a segment. The adaptive sampling technique may include iteratively splitting the segment into two or more intervals of equal or unequal length.

The adaptive sampling technique may include determining convergence at two or more points in each segment. The method may include generating, by the processor, a seismic image of the subsurface area using the inverted data.

One or more example non-transitory machine-readable storage media are for storing instructions for producing a seismic wave velocity model of a subsurface area. The instructions are executable by one or more processing devices to perform one or more operations.

The operations include receiving, from a seismic receiver, seismic data input comprising a recorded seismic wave field. The operations include receiving, an initial 1D velocity model of the subsurface area. The operations include receiving, data input comprising a maximum misfit value and maximum iteration value. The operations include determining, a Laplace-Fourier transform of the recorded seismic wave field.

The operations include setting, a current 1D velocity model to the initial 1D velocity model. The operations include setting, an iteration value n to zero. The operations include regenerating, the current 1D velocity model to generate inverted data representing the subsurface area.

The operations include generating, a modeled synthetic wave field in the Laplace-Fourier domain using the current 1D velocity model (step (i)). The operations include comparing the modeled synthetic wave field with the recorded seismic wave field to determine a misfit value (step (ii)). The operations include if the determined misfit value is less than the maximum misfit value, outputting the current 1D velocity model as the final 1D velocity model (step (iii)). The operations include if the determined misfit value is greater than the maximum misfit value, and if the iteration value is equal to or greater than the maximum iteration value, outputting the current 1D velocity model as the final velocity model (step (iv)). The operations include, if the determined misfit value is greater than the maximum misfit value, and if the iteration value is less than the maximum iteration value, generating a corrected current 1D velocity model using a gradient of a misfit function and setting the iteration value to n+1, and repeating steps (i) through (v).

The operations may include performing an upscaling of a plurality of 1D velocity models to produce a 3D velocity model.

Generating a modeled synthetic wave field in the Laplace-Fourier domain may include calculating an inverse Hankel transformation integral using an iterative horizontal wavenumber line segmentation process to determine locations for sampling the integrand and the upper limit at which to truncate the transformation integral. The segmentation process may include determining an end to a segment using the Newton-Raphson method.

Generating a modeled synthetic wave field in the Laplace-Fourier domain may include calculating an inverse Hankel transformation using an adaptive sampling technique to determine horizontal wavenumbers to be sampled in a segment. The adaptive sampling technique may include iteratively splitting the segment into two or more intervals of equal or unequal length.

The adaptive sampling technique may include determining convergence at two or more points in each segment. The operations may include generating, by the processor, a seismic image of the subsurface area using the inverted data.

An example system includes one or more non-transitory machine-readable storage media storing instructions for producing a seismic wave velocity model of a subsurface area. The system includes one or more processing devices to execute the instructions to perform one or more operations.

The operations include receiving, from a seismic receiver, seismic data input comprising a recorded seismic wave field. The operations include receiving, an initial 1D velocity model of the subsurface area. The operations include receiving, data input comprising a maximum misfit value and maximum iteration value. The operations include determining, a Laplace-Fourier transform of the recorded seismic wave field.

The operations include setting, a current 1D velocity model to the initial 1D velocity model. The operations include setting, an iteration value n to zero. The operations include regenerating, the current 1D velocity model to generate inverted data representing the subsurface area.

The operations include generating, a modeled synthetic wave field in the Laplace-Fourier domain using the current 1D velocity model (step (i)). The operations include comparing the modeled synthetic wave field with the recorded seismic wave field to determine a misfit value (step (ii)). The operations include if the determined misfit value is less than the maximum misfit value, outputting the current 1D velocity model as the final 1D velocity model (step (iii)). The operations include if the determined misfit value is greater than the maximum misfit value, and if the iteration value is equal to or greater than the maximum iteration value, outputting the current 1D velocity model as the final velocity model (step (iv)). The operations include, if the determined misfit value is greater than the maximum misfit value, and if the iteration value is less than the maximum iteration value, generating a corrected current 1D velocity model using a gradient of a misfit function and setting the iteration value to n+1, and repeating steps (i) through (v).

The operations may include performing an upscaling of a plurality of 1D velocity models to produce a 3D velocity model.

Generating a modeled synthetic wave field in the Laplace-Fourier domain may include calculating an inverse Hankel transformation integral using an iterative horizontal wavenumber line segmentation process to determine locations for sampling the integrand and the upper limit at which to truncate the transformation integral. The segmentation process may include determining an end to a segment using the Newton-Raphson method.

Generating a modeled synthetic wave field in the Laplace-Fourier domain may include calculating an inverse Hankel transformation using an adaptive sampling technique to determine horizontal wavenumbers to be sampled in a segment. The adaptive sampling technique may include iteratively splitting the segment into two or more intervals of equal or unequal length.

The adaptive sampling technique may include determining convergence at two or more points in each segment. The operations may include generating, by the processor, a seismic image of the subsurface area using the inverted data.

### BRIEF DESCRIPTION OF THE DRAWINGS

These and other features, aspects, and advantages of the present technologies will become better understood with regard to the following descriptions, claims, and accompanying drawings. It is to be noted, however, that the drawings illustrate only several implementations and are therefore not to be considered limiting.

FIG. 1 is a flow chart describing a process for generating a 1D velocity model from seismic wave field input data, using Laplace-Fourier Full Waveform Inversion (FWI).

FIGS. 2A-2C are graphs illustrating the steps of the KRMAX algorithm.

FIGS. 3A-3D are graphs illustrating the steps of the ADS algorithm.

FIG. 4 is a graph illustrating an example velocity model used with one or more embodiments described in this specification.

FIG. 5 shows graphs illustrating modeled data for frequencies f={5, 25}Hz and damping σ={3, 10}s⁻¹, at a depth of 20 m. Line: inverse Hankel transform using fine sampling and the trapezoidal rule; Dots: inverse Hankel transform using KRMAX/ADS.

FIG. 6 shows graphs illustrating modeled data for frequencies f={5, 25}Hz and damping σ={3, 10}s⁻¹, at a depth of 125 m. Line: inverse Hankel transform using fine sampling and the trapezoidal rule; Dots: inverse Hankel transform using KRMAX/ADS.

Like reference numerals in the figures indicate like elements.

### DETAILED DESCRIPTION

Seismic imaging includes the analysis of sound waves, which may be reflected, refracted, or absorbed by underground rock structures. Generally, seismic imaging techniques include generating intense acoustic energy (sound) by a source and directing the energy into the ground. Receivers, for example, geophones, which are analogous to microphones, may detect sound waves or “echoes” that travel back (up) through the ground. The parameters of these echo waves (for example, intensity, time, amplitude, or wavelength) may be recorded and analyzed on a computer. The wave signals are analyzed and may be converted into images of the geologic structure.

As part of the analysis and image generation, a technique known as waveform inversion may be employed to generate a seismic model of a subterranean formation, for example, a hydrocarbon-bearing rock formation. Wave measurements and analysis may be used, for example, to reveal oil- or gas-bearing formations or reservoirs. A specific type of waveform inversion is known as Full Waveform Inversion (FWI), which internally employs full wave field modeling, that is, modeling both amplitudes and arrival times of seismic events. FWI may be used to develop seismic velocity models that can be in turn used to produce seismic reflectivity images.

The quality of the seismic reflectivity images strongly depends on the quality of the corresponding seismic velocity model. A technique known as 3D FWI in the Laplace-Fourier domain may be used for retrieving accurate velocity models, but this technique may be computationally expensive. It is possible, however, to approximate a 3D medium by an effective 1.5D medium and invert for independent 1D-velocity profiles that can be then merged and upscaled to form a 3D volume. In order to achieve this task, a computationally efficient Laplace-Fourier 1.5D forward modeling solution may be used. A forward modeling solution as described in this specification is used internally by the Laplace-Fourier FWI.

This specification describes algorithms and workflows to accelerate the computation of Laplace-Fourier 1.5D forward modeling by means of an adaptive sampling technique.

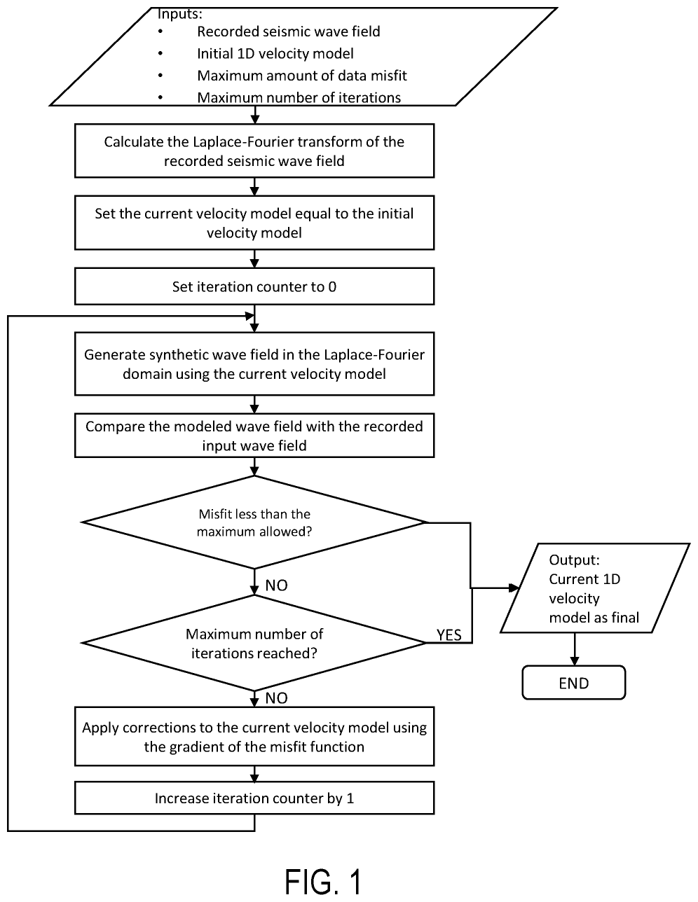

This specification describes a technology including new algorithms and workflows for implementing a fast calculation of Laplace-Fourier 1.5D forward modeling. The resulting model may then be used in various decision-making processes including well-placement, the decision to construct (or not construct) a new well, the decision to take additional sampling data (for example, seismic data, among other possible data types) in a specific geographic area, the decision to continue to operate a production well (or alternatively, to take a well out of production) based on one or more model predictions, and/or other decisions that result in a real-world action step being taken. For example, once a 1D or 1.5D model is finalized, the embodiments disclosed herein may also include taking any of these additional actions steps (i.e., constructing a well in a specific location, taking a well out of production, performing data sampling (for example, seismic data) in a specific geographic area, as well as other action steps as disclosed here etc.) as a result of the model predictions. An example workflow for a method to produce a 1D seismic velocity model is shown in FIG. 1. The method may include receiving from one or more seismic receivers, for example, geophones, seismic data input, which takes the form of a recorded seismic wave field. An initial 1D velocity model of the subsurface area is set as a starting point of the iterative inversion process. Moreover, a maximum misfit value and maximum iteration value are set. The purpose of a misfit function in FWI modeling is to help determine the difference between recorded seismic data and the numerically modeled seismic wave fields.

As next step, a Laplace-Fourier transform of the recorded seismic wave fields is determined. A current 1D velocity model is then set to the initial 1D velocity model and an iteration value is set to zero. A modeled synthetic wave field in the Laplace-Fourier domain is then (re)generated using the current 1D velocity model. The modeled synthetic wave field is compared with the recorded seismic wave field to determine a misfit value. If the determined misfit value is less than the maximum misfit value, the current 1D velocity model is outputted as the final 1D velocity model. If the determined misfit value is greater than the maximum misfit value, and if the iteration value is equal to or greater than the maximum iteration value, the current 1D velocity model is outputted as the final 1D velocity model. If the determined misfit value is greater than the maximum misfit value, and if the iteration value is less than the maximum iteration value, a corrected 1D current velocity model is generated using the gradient of the misfit function. The iteration value is increased by 1, the steps are repeated starting at the generation of a modeled synthetic wave field in the Laplace-Fourier domain using an updated 1D velocity model.

The final outputted 1D velocity model constitutes the result of Laplace-Fourier full waveform inversion (FWI). A plurality of such 1D velocity models can be generated using different recorded wave fields as input. These 1D velocity models can then be upscaled to form a 3D model. The 3D model may be displayed as an image on a computer screen. It may also be used as a starting model for 3D FWI or to perform seismic migration.

Various steps of the present embodiments that are computationally intensive may be off-loaded from a central processing unit (CPU) to one or more computing components (such as a graphics processing unit (GPU), a tensor processing unit (TPU), an application-specific integrated circuit (ASC), and/or a field programmable gate array (FPGA)) that are specifically configured for parallelization (that is, parallel computing). For example, referring to FIG. 1, the CPU may: receive inputs, calculate the Laplace-Fourier transform, set the current velocity model, and/or set the iteration counter. The CPU may then pass inputs (i.e., the Laplace—Fourier transform and the current velocity model) to at least one of a GPU, TPU, ASIC, and/or FPGA). Generating a synthetic wave field, comparing the modeled wave, assessing both the misfit and the number of iterations, applying corrections, and increasing the iteration counter may all be performed by the GPU, TPU and/or ASIC (or FPGA) as many times as is necessary for the iteration loop to complete. The GPU, TPU and/or ASIC (or FPGA) may then pass the current ID model back to the CPU for outputting, thereby completing the process. As such, the present embodiments may also include one or more systems that include a CPU configured to perform one or more steps described herein, the CPU being communicatively coupled to at least one of a GPU, TPU, ASIC, and/or FPGA configured to receive inputs from the CPU and perform certain other steps described herein, prior to passing computational results (for example, a final version of the current 1D or 1.5D model) back to the CPU for outputting to the user. In some embodiments, the iteration counter may be set by the GPU, TPU and/or ASIC (or FPGA) rather than the CPU. In some embodiments, the entirety of the method described in FIG. 1 is executed on the CPU. In some embodiments, one or more action steps (as disclosed herein) may be taken as a result of predictions from the finalized model(s).

In some implementations, the technologies described in this specification provide a novel approach to carry out the numerical integration used in the calculation of the inverse Hankel transformation, a process required by the Laplace-Fourier 1.5D forward modeling when generating the modeled synthetic wave field. The technologies include the implementation of two novel algorithms (KRMAX and ADS,) for the automatic choice of truncation limit (upper horizontal wavenumber) for the Hankel transform integral, as well as the automatic sampling of the integrand. Moreover, the technologies include a novel algorithm for carrying out the numerical integration, combining a piecewise-linear approximation of the integrand with analytic expressions for calculating the integral of the product of a piecewise-linear function with a Bessel function of the first kind of order 0. This latter algorithm is fully automatic and does not require setting any input parameters in contrast to other methods. The accuracy of the overall implementation and workflow has been tested on synthetic data.

The technologies described in this specification provide a technical advantage over the available methods by improving processing speed and ease of use. For example, the method described in Tripathi (2014) is more general, as it can evaluate Hankel transforms of arbitrary order, but its formulation involves an infinite series that must be truncated. Choosing the number of terms to keep for an accurate result is not straightforward, especially for an application such FWI, where the inverse Hankel transform needs to be calculated for a function that changes every iteration. Choosing to keep a very high number of terms is an option, but may lead to excessive evaluations of Bessel functions, which may render the process (computationally) expensive. The methods described in this specification have a more limited scope, as they are designed specifically for the Hankel transform of order zero, but they use a different formulation that avoids the need to explicitly truncate an infinite series. Determining the horizontal wavenumber at which to truncate the integration involved in calculating the Hankel transform is also a detail that is often not discussed, e.g., in Krenk (1989), or is a piece of information assumed to be known, e.g., in Xu (1985) or in Hai-Ming (2001). The algorithm KRMAX included in the methods described in this specification means that the end user does not have to set an explicit upper horizontal wavenumber, that might need to vary per problem, but a rather easier to set tolerance value. Moreover, the technologies described may be used not only for FWI, but may also be used with techniques using the computation of an inverse Hankel transformation, such as electromagnetic (EM)/optical wave field propagation and ocean acoustics modeling.

The technologies described in this specification relate to velocity modeling and inversion for seismic exploration. The technologies may improve the reliability of seismic images, thus enhancing the discovery of new resources. The described approach may generally be used in any other technology that requires the computation of an inverse Hankel transformation.

In some implementations, the technologies described in this specification solve the problem of speeding up 1.5D forward modeling in the Laplace-Fourier domain. In an inversion process the forward modeling problem has to be solved multiple times. The proposed technologies may be used to speed up the Laplace-Fourier FWI process significantly.

Full waveform inversion (FWI) is becoming the current standard technology to derive seismic velocity models but this technology requires a very good initial velocity model and is computationally expensive, especially in its 3D implementations. 3D FWI in the Laplace-Fourier domain is less sensitive to the initial velocity model but it can be still comparatively computationally expensive. It is possible to locally approximate the 3D medium by an effective 1.5D medium and invert for independent 1D velocity profiles that can be then merged and upscaled to a 3D volume. This specification describes technologies including a novel algorithm for implementing a fast calculation of Laplace-Fourier 1.5D forward modeling.

The 1.5D Laplace-Fourier forward modeling method includes two steps. The first step is to solve a version of the depth-separated 1D wave equation. For the purposes of the present disclosure, it takes the form

$$[ \frac{{\partial }^{2}}{\partial {z}^{2}} - ( {( \frac{s}{c ( z )} )}^{2} + {k}_{r}^{2} ) ] \tilde{p} ( {k}_{r} , z ; s ) = - f ( {k}_{r} , z ; s ) , \qquad ( 1 )$$

which is the constant density acoustic Laplace-Fourier-Hankel wave equation. Here s=σ+jω is the Laplace-Fourier complex frequency. Its two components are the damping factor σ (real part) and the angular frequency ω (imaginary part). Variable z represents the depth, r the offset and kᵣ the horizontal wavenumber. The modeled wave field, the forcing term, and the 1D velocity model are denoted with \tilde{p}(kᵣ, z; s), f (kᵣ, z; s) and c(z) respectively.

The second step is to perform the inverse Hankel transform in order to transform the solution from the Laplace-Fourier-Hankel to the Laplace-Fourier domain (converting the horizontal wavenumber dimension to offset):

$$\begin{matrix}p ( r , z ; s ) = {\int }_{0}^{∞} \tilde{p} ( {k}_{r} , z ; s ) {k}_{r} {J}_{0} ( {rk}_{r} ) {dk}_{r} \\ = {\int }_{0}^{∞} \tilde{g} ( {k}_{r} , z ; s ) {J}_{0} ( {rk}_{r} ) {dk}_{r} ,\end{matrix} \qquad ( 2 )$$

where J₀( ) is the Bessel function of the first kind of order 0 and \tilde{g}(kᵣ, z; s)=\tilde{p}(kᵣ, z; s)kᵣ.

The technologies described in this specification address the challenges associated with carrying out (2). It is assumed that there exists a modeling function L( ) such that

\tilde{p}(kᵣ,z;s)=L(kᵣ,z;s). (3)

Although the acoustic case is described in detail in this specification, in principle L( ) could be extended to handle more complex propagation, such as through elastic/anisotropic media.

Any scheme used to calculate the integral in (2) has to address at least the following issues:

First is the truncation of the integral. In practice the integral has to be truncated at some maximum horizontal wavenumber. For accurate modeling the value should be high enough so that all significant contributions of the integrand are included.

Second is the choice of horizontal wavenumbers at which to evaluate \tilde{g}(kᵣ, z; s). As evaluating \tilde{g}(kᵣ, z; s) involves solving the ordinary differential equation (1) it is a relatively expensive operation. To keep modeling fast, evaluations of \tilde{g}(kᵣ, z; s) should be kept at a minimum. For accurate modeling, on the other hand, sampling should be dense enough to accurately capture the shape of \tilde{g}(kᵣ, z; s), which might be characterized by complications, such as the presence of pseudopoles and rapid magnitude variations. Depending on how the integration is performed, the oscillatory nature of J₀(rkᵣ) may also need to be taken into account when deciding the sampling requirements.

Third is the choice of an integration scheme that carries out (2), given a set of discrete horizontal wavenumbers and the values of the modeling function at each of those.

The methods described in the present specification address the first two issues using a combination of two algorithms, which will be referred to as KRMAX and ADS. KRMAX determines where the truncation of the integral should occur. ADS uses adaptive sampling to determine the horizontal wavenumbers to be sampled. The set of chosen horizontal wavenumbers is then used to construct a piecewise-linear approximation of \tilde{g}(kᵣ, z; s). For this approximation, the integral (2) can be computed analytically, which is the approach to addressing the third issue listed above.

The technologies described in this specification exploit the fact that \tilde{g}(kᵣ, z; s) is generally varying much slower than J₀(rkᵣ), except for regions near pseudopoles, especially when the product rkᵣ is large. This prompts treating \tilde{g}(kᵣ, z; s) and J₀(rkᵣ) separately, rather than their product as a single entity in the integration scheme. Adaptive sampling allows one to build the piecewise-linear approximation by sampling densely in areas regions where \tilde{g}(kᵣ, z; s) varies quickly and sparsely in regions of slow variation. Thus, the number of evaluations of \tilde{g}(kᵣ, z; s) is kept at a minimum. Keeping the number of evaluations of \tilde{g}(kᵣ, z; s) at a minimum helps minimize the computational effort spent in solving (1). Solving (2) analytically has certain advantages in that it is not necessary to set any additional parameters and that it is exact for all offset ranges. The accuracy of the inverse Hankel transform computed this way is only limited by the accuracy of the piecewise-linear approximation. In total, the KRMAX/ADS approach only requires setting two parameters that are scale-independent.

### The KRMAX Algorithm

KRMAX works by dividing the horizontal wavenumber line into segments. The number of these segments is not known a priori, but is determined by an iterative process. Each of these segments has a minimum and a maximum length of Δkᵣ and 10Δkᵣ respectively, where

$$Δ {k}_{r} = \frac{ω}{{min}_{z} \{ c ( z ) \}} . \qquad ( 4 )$$

The value of Δkᵣ is chosen such that it lies approximately at the beginning of the evanescent part of \tilde{p}(kᵣ, z; s). The algorithm starts by calling ADS on the segment [0, Δkᵣ]. ADS returns a set of horizontal wavenumbers, [symbol] ^{s} as well as a set of corresponding values [symbol] ^{s} with [symbol] ᵢ^{s}=\tilde{g}( [symbol] ᵢ^{s}, z; s). These are then appended to initially empty sets [symbol] and \tilde{g}. After appending,

[symbol]

={kᵣ_{ᵢ}}ᵢ₌₀^{N},kᵣ_{₁}<kᵣ_{₂}< . . . <kᵣ_{_{N}}, and

[symbol]

={\tilde{g}(kᵣ_{ᵢ},z;s)}ᵢ₌₀^{N}={\tilde{g}ᵢ}ᵢ₌₀^{N}.

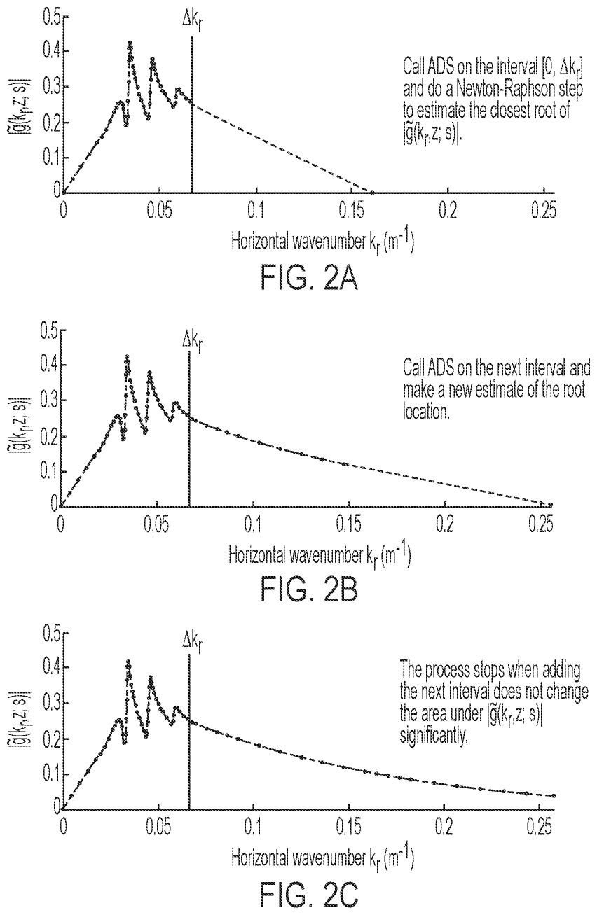

This concludes the process for the first segment or interval. (See FIG. 2A). The next segment starts from k_{r,start}=\tilde{g}_{N}, which is the last element of the first segment. Its end is determined by the Newton-Raphson step,

$${k}_{r , end} = {k}_{{r}_{N}} - \frac{\tilde{g} ( {k}_{{r}_{N}} , z ; s )}{\partial g ( {k}_{r} , z ; s ) / \partial {k}_{r} {\vert}_{{k}_{r} = {k}_{{r}_{N}}}} \approx {k}_{{r}_{N}} - \frac{\tilde{g} ( {k}_{{r}_{N}} , z ; s )}{\frac{\tilde{g} ( {k}_{r} , z ; s ) - \tilde{g} ( {k}_{{r}_{N - 1}} , z ; s )}{{k}_{{T}_{N}} - {k}_{{T}_{N - 1}}}} ,$$

where the first derivative at the end of the previous segment has been approximated using the last two elements of [symbol] . In some implementations, other approximations to the first derivative, possibly involving more elements of [symbol] , may also be used. If required, k_{r,end} is clipped so that k_{r,end}∈[k_{r,start}+Δkᵣ, k_{r,start}+10Δkᵣ]. This guards against issues such as having k_{r,end}≤k_{r,start} or very small (big) segments caused by very big (small) values of the first derivative. Then, ADS is called on the new segment or interval and the same procedure is repeated (See FIG. 2B). The algorithm stops when the area below |\tilde{g}(kᵣ, z; s)| in the segment or interval to be added is smaller than τₖᵣₘₐₓ times the total area below |\tilde{g}(kᵣ, z; s)| on all previous segments (See FIG. 2C). The areas are estimated using the trapezoidal rule at the sampled locations.

Using the Newton-Raphson method offers a practical way of determining an upper horizontal wavenumber at which the evanescent part of the wave field has become sufficiently weak. Truncating there is expected to capture most significant contributions of \tilde{g}(kᵣ, z; s) while carrying out the inverse Hankel transform (2). It is noted that the described approach differs from known methods: for example, Georgiadis et al. (1999) also employ the Newton-Raphson method in their approach, but their purpose for doing so is to locate Rayleigh peaks, rather than to implement the segmentation described in this specification.

The ADS algorithm

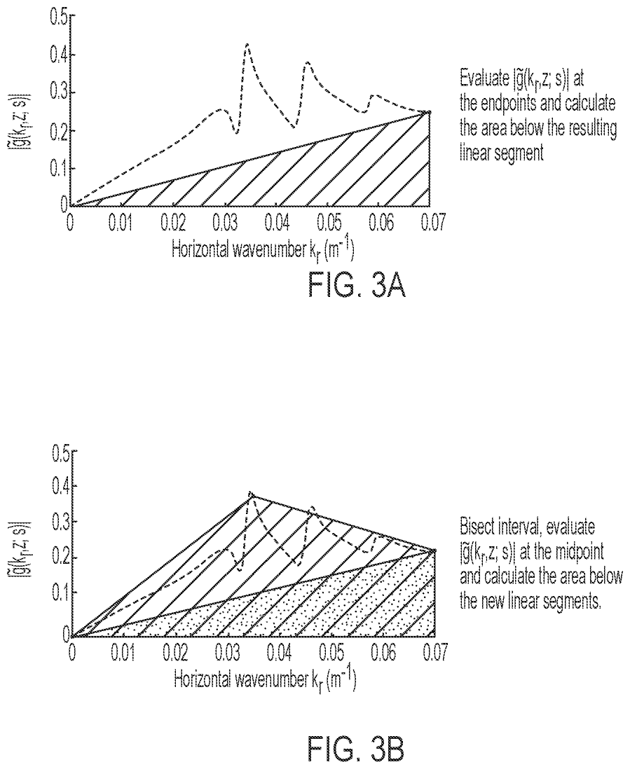

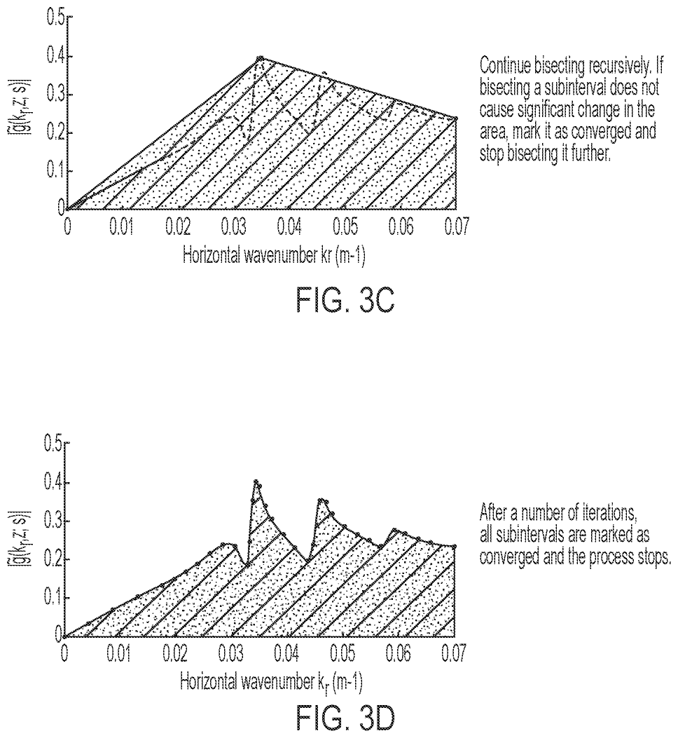

The ADS algorithm is based on the method outlined in Krenk (1989). The method works within a segment [k_{r,start}, k_{r,end}] and calculates the area below the resulting linear segment. (See FIG. 3A). The segment is split into two subintervals [k_{r,start}, k_{r,split}] and [k_{r,split}, k_{r,end}], with k_{r,split} being the midpoint between k_{r,start} and k_{r,end} (FIG. 3B). In some embodiments, the midpoint may coincide with a localize maximum value of |\tilde{g}(kᵣ_{ᵢ}, z; s)|. Then, k_{r,split} is appended to [symbol] ^{s} and \tilde{g}(k_{r,split}, z; s) to [symbol] ^{s}. The two subintervals are further bisected in the following iterations (See FIG. 3C). After each bisection, the algorithm decides whether the subinterval has converged or not. To check convergence, ADS compares the total area after the bisection relative to the total areal before the bisection. If the ratio is smaller than τ_{ads}, the two new subsections are marked as converged and the algorithm stops when all subintervals have been marked as such (See FIG. 3D).

Note that when (kᵣ_{ᵢ}, |\tilde{g}(kᵣ_{ᵢ}, z; s)|), (k_{r,split}, |\tilde{g}(k_{r,split}, z; s)|) and (kᵣ_{ᵢ₊₁}, |\tilde{g}(kᵣ_{ᵢ₊₁}, z; s)|) are collinear, the total area does not change after splitting, which means that the two new subintervals will be marked as converged. This is the desired behavior, as long as \tilde{g}(kᵣ, z; s) is well approximated by a line segment connecting \tilde{g}(kᵣ_{ᵢ}, z; s) and \tilde{g}(kᵣ_{ᵢ₊ₗ}, z; s). Further division of the interval would be wasteful, since a sufficient approximation has been already constructed. A complication arises, however, if these points happen to be collinear by chance and otherwise g(kᵣ, z; s) does not have a linear shape in the interval [kᵣ_{ᵢ}, kᵣ_{ᵢ₊₁}]. Then the interval is erroneously marked as converged. Two measures can be taken to mitigate this problem. The first is to not bisect exactly, but add some random jitter when determining the split point. The second measure is to require that the convergence criterion is met for additional points in [kᵣ_{ᵢ}, kᵣ_{ᵢ₊₁}]. This increases the robustness of the algorithm, but it comes at the expense of extra evaluations of \tilde{g}(kᵣ, z; s). These modifications extend beyond the methods found in Krenk (1989) and are more robust.

### Inverse Hankel Transform of the Approximated Wave Field

The sets [symbol] and [symbol] returned by KRMAX/ADS can be used to construct a piecewise-linear approximation to \tilde{g}(kᵣ, z; s),

$$\tilde{g} ( {k}_{{r}_{N}} , z ; s ) = {\sum }_{i = 1}^{N - 1} [ \frac{{\tilde{g}}_{i + 1} - {\tilde{g}}_{i}}{{k}_{{r}_{i + 1}} - {k}_{{r}_{i}}} ( {k}_{r} - {k}_{{r}_{i}} ) + {g}_{i} ] Π ( {k}_{{r}_{i}} , {k}_{{r}_{i + 1}} ) , \qquad ( 5 )$$

where Π(kᵣ_{ᵢ}, kᵣ_{ᵢ₊₁}) is the boxcar function.

$$Π ( {k}_{{r}_{i}} , {k}_{{r}_{i + 1}} ) = \{ \begin{matrix}1 , & when {k}_{{r}_{i}} \leq {k}_{r} \leq {k}_{{r}_{i + 1}} \\ 0 , & otherwise .\end{matrix}$$

Replacing \tilde{g}(kᵣ, z; s) with \tilde{g}ₗᵢₙ(kᵣ, z) in (2), yields

p(r,z;s)≈∫₀^{∞}\tilde{g}ₗᵢₙ(kᵣ,z;s)J₀(rkᵣ)dkᵣ, (6)

By using KRMAX/ADS to approximate \tilde{g}(kᵣ, z; s) rather than \tilde{p}(kᵣ, z; s), it becomes easy to calculate the integral (6), given the fact that the integrand for each segment [kᵣ_{ᵢ}, kᵣ_{ⱼ₊₁}] is the product of a first-order polynomial and a zeroth-order Bessel function of the first kind. Substituting (5) into (6) and following the derivation steps found in the section “Analytic evaluation of the inverse Hankel transform”, we arrive to

$$p ( r , z ; s ) \approx - \frac{Δ {A}_{1} - {k}_{{r}_{2}} Δ {B}_{1}}{{k}_{{r}_{2}} - {k}_{{r}_{1}}} {\tilde{g}}_{1} + {\sum }_{i = 1}^{N - 1} ( \frac{Δ {A}_{1} - {k}_{{r}_{2}} Δ {B}_{i - 1}}{{k}_{{r}_{2}} - {k}_{{r}_{i - 1}}} - \frac{Δ {A}_{i} - {k}_{{r}_{i + 1}} Δ {B}_{i}}{{k}_{{r}_{i + 1}} - {k}_{{r}_{i}}} ) {\tilde{g}}_{i} + \frac{Δ {A}_{N - 1} - {k}_{{r}_{N - 1}} Δ {B}_{i - 1}}{{k}_{{r}_{N}} - {k}_{{r}_{N - 1}}} {\tilde{g}}_{N} .$$

The values ΔAᵢ and ΔBᵢ are given by

$$Δ {A}_{i} = {A}_{i + 1} - {A}_{i} , {A}_{i} = \frac{{k}_{{r}_{i}}}{r} {J}_{1} ( {rk}_{{r}_{i}} ) , Δ {B}_{i} = {B}_{i + 1} - {B}_{i} , \qquad ( 7 )$$

$${B}_{i} = \frac{π {k}_{{r}_{i}}}{2} [ {J}_{0} ( {rk}_{{r}_{i}} ) ( \frac{2}{π} - {H}_{1} ( {rk}_{{r}_{i}} ) ) - {H}_{0} ( {rk}_{{r}_{i}} ) {J}_{- 1} ( {rk}_{{r}_{i}} ) ] .$$

Here Aᵢ and Bᵢ are given in terms of Bessel functions of the first kind and v-th order, Jᵥ( ) and Struve functions Hᵥ( ). To evaluate the Struve functions involved, an accurate and fast method was used discussed in (Theodoulidis, On the closed-form expression of Carson's integral, 2015).

The method uses Chebyshev expansion for smaller values of the argument and rational approximation for the larger ones, and a Matlab implementation can be found in (Theodoulidis, Struve functions, 2019).

### SYNTHETIC EXAMPLE

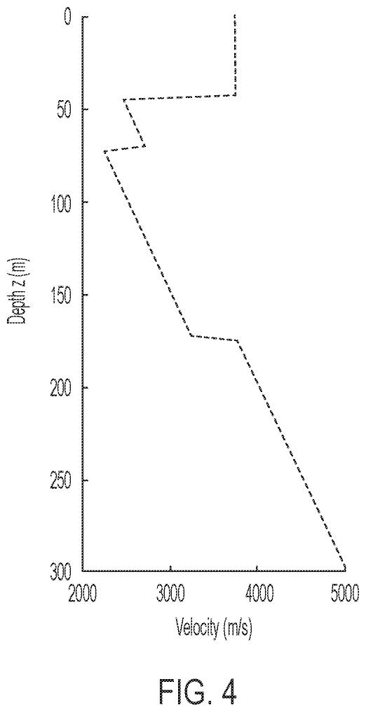

To test the correctness of the method the following test was performed. The velocity model shown in FIG. 4 was used to model data at offsets r from 25 m to 500 m, with a step of 12.5 m. The data was modeled at combinations of frequencies of 5 Hz and 25 Hz and damping parameters of 3 s⁻¹ and 10 s⁻¹.

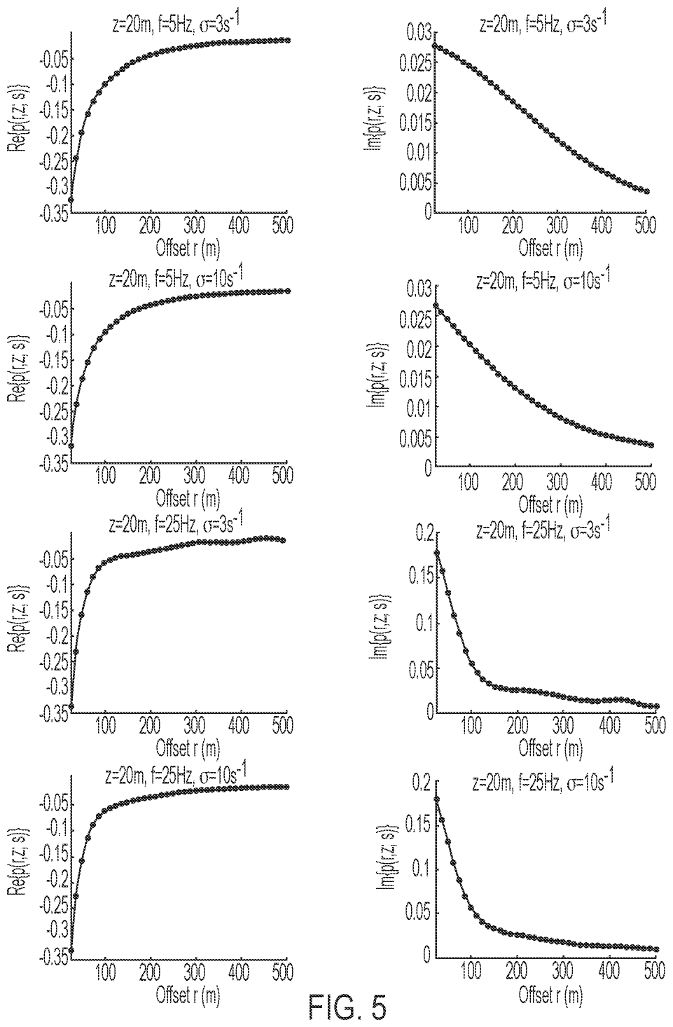

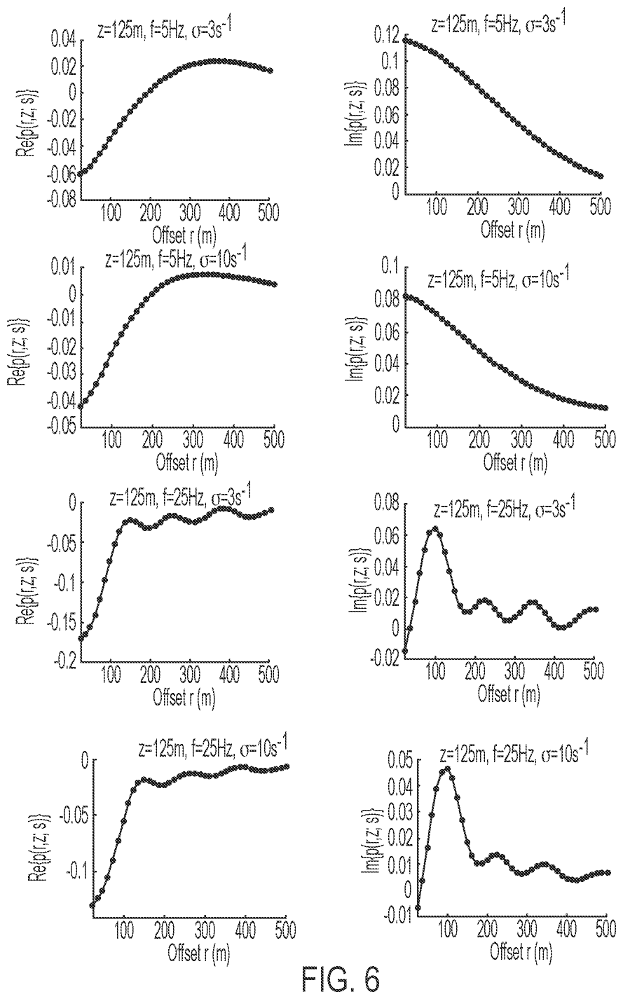

The results at depths z=20 m and z=125 m are shown in FIG. 5 and FIG. 6 respectively. For each example, modeling was carried out twice, each time using a different way to calculate the inverse Hankel transform. First, the trapezoidal rule was used to numerically carry out the integration (2), using very fine sampling. Then, KRMAX/ADS was used, with τ_{ads}=τₖᵣₘₐₓ=10⁻³, followed by the analytic integration (6). As can be seen in FIG. 5 and FIG. 6, the data produced by the two approaches match very well, both in the real and the imaginary part. The trapezoidal rule integration required 5 to 6 times denser sampling: the method described in the present specification allows solving the inverse Hankel transformation integration problem in roughly 5 to 6 times faster than using the trapezoidal rule, as the trapezoidal rule needs to accommodate for the rapid oscillations of the Bessel function.

### Pseudocode for the ADS and KRMAX Algorithms

Both the ADS and KRMAX algorithms make use of the function

$$T ( {x}_{1} , {x}_{2} , {y}_{1} , {y}_{2} ) = \vert \frac{( {x}_{2} - {x}_{1} ) ( {y}_{1} + {y}_{2} )}{2} \vert ,$$

which calculates the absolute value of the trapezoidal rule of a function evaluated at x₁ and x₂, with corresponding values y₁ and y₂.

The KRMAX algorithm takes as input the forward modeling function L( ), Δkᵣ as defined in (4), the depth and complex frequency at which to model (z and s respectively), as well as two parameters that are used in stopping criteria, τ_{ads} and τₖᵣₘₐₓ. As output it provides a set of horizontal wavenumbers, [symbol] , and a set of modeled data at those horizontal wavenumbers.

```
Algorithm: KRMAX
Input. L( ), Δkᵣ, z, s, τ_{ads} τₖᵣₘₐₓ
kᵣ_{ₛₜₐᵣₜ} ← 0
kᵣ_{_{end}} ← Δkᵣ [symbol]
← { }, [symbol]     ← { }, [symbol]     ← { }
{ [symbol]   ^{s}, [symbol]    ^{s}, [symbol]    ^{s}} ← ADS(kᵣ_{ₛₜₐᵣₜ}, kᵣ_{_{end}}, L( ), z, s, τads)
do [symbol]
  ← [symbol]    ∪ [symbol]    ^{s}, [symbol]     ← [symbol]     ∪ [symbol]    ^{s}, [symbol]     ← [symbol]     ∪ [symbol]    ^{s}
  N ← | [symbol]   |
  k_{r,start} ← k_{r,end}
  if N ≥ 2 then
    d ← ( [symbol]   _{N} − [symbol]    _{N-1})/( [symbol]   _{N} − [symbol]    _{N-1})
    k_{r,cand} ← k_{r,start} − [symbol]    _{N}/d
    k_{r,end} ← min{max{k_{r,start} + Δkᵣ, k_{r,cand}}, k_{r,start}
            + 10Δkᵣ}
  else
    k_{r,end} ← k_{r, start} + Δkᵣ
  end if
  { [symbol]   ^{s}, [symbol]    ^{s}, [symbol]    ^{s}} ← ADS(Kᵣ_{ₛₜₐᵣₜ}, Kᵣ_{_{end}}, Q( ), z, s, τ_{ads})
while (z!v2)/CZMV,) > τₖᵣₘₐₓ
Output: [symbol]     , [symbol]
```

In each iteration of KRMAX, an interval [k_{r,start}, k_{r,end}] is determined and ADS is called to adaptively sample it. ADS works by dividing this interval successively into smaller subintervals and sampling \tilde{g}(kᵣ, z; s) at the edges of those subintervals. The process stops once dividing further does not significantly change the estimated area below \tilde{g}(kᵣ, z; s). The relevant tolerance is controlled via τ_{ads}. The output is a set of sampled horizontal wavenumbers, [symbol] ^{s} within the interval [k_{r,start}, k_{r,end}], as well as the corresponding values of \tilde{g}(kᵣ, z; s) as members of the set [symbol] ^{s}.

```
Algorithm: ADS
Input: k_{r,start}, K_{r,end}, L( ), z, s, τ_{ads} [symbol]
^{s} ← {k_{r,start}, K_{r,end}} [symbol]
^{s} ← {L(k_{r,start}, z, s), L(k_{r,end}, z, s)} [symbol]
^{s} ← {0} [symbol]
^{s} ← {T( [symbol]   ₁^{s}, [symbol]   ₂^{s}, [symbol]   ₁^{s}, [symbol]   ₂^{s})}
while ∃ [symbol]   ᵢ^{s} : [symbol]    ᵢ^{s} = 0
  for i = 1 to | [symbol]   ^{s}|−1
    if [symbol]    ᵢ^{s} = 0 then
      k_{r,split} ← ( [symbol]   ᵢ^{s} + [symbol]    ᵢ₊₁^{s})/2
      \tilde{g}ₛₚₗᵢₜ ← L(k_{r,split}, z, s)
      vₗₛₚₗᵢₜ ← T( [symbol]   ᵢ^{s}, k_{r,split}, [symbol]   ᵢ^{s}, \tilde{g}ₛₚₗᵢₜ)
      vᵣₛₚₗᵢₜ ← T(kᵣₛₚₗᵢₜ, [symbol]   ᵢ₊₁^{s}, \tilde{g}ₛₚₗᵢₜ, [symbol]    ᵢ₊₁^{s}) [symbol]
      ← { [symbol]   ₁^{s}, ..., [symbol]    ᵢ^{s}, kᵣₛₚₗᵢₜ, [symbol]    ᵢ₊₁^{s}, ..., [symbol]    _{N}} [symbol]
      ← { [symbol]   ₁^{s}, ..., [symbol]    ᵢ^{s}, \tilde{g}ₛₚₗᵢₜ, [symbol]    ᵢ₊₁^{s}, ..., [symbol]    _{N}^{s}
      if |(Vᵢ^{s} − vₗₛₚₗᵢₜ − vᵣₛₚₗᵢₜ)/ (Σⱼ₌₁^{N-1}Vᵢ^{s})| ≤ τ_{ads}
      then [symbol]
        ^{s} ← { [symbol]   ᵢ^{s}, ..., [symbol]    ᵢ₋₁^{s}, 0, 0, [symbol]    ᵢ₊₁^{s}, ... [symbol]    _{N-1}^{s}}
      else [symbol]
        ^{s} ← { [symbol]   ᵢ^{s}, ..., [symbol]    ᵢ₋₁^{s}, 1, 1, [symbol]    ᵢ₊₁^{s}, ... [symbol]    _{N-1}^{s}}
      end if [symbol]
      ← { ₁^{s}, ...,  ᵢ₋₁^{s}, vₗₛₚₗᵢₜ, vᵣₛₚₗᵢₜ,  ᵢ₊₁^{s}, ...  _{N-1}^{s}
    end if
  end for
end while
Output: [symbol]    ^{s}, [symbol]    ^{s}, [symbol]    ^{s}
```

### Analytic Evaluation of the Inverse Hankel Transform

The inverse Hankel transform of the piecewise-linear approximation to \tilde{g}(kᵣ, z; s) can be carried out analytically. Substituting (5) into (6) yields

$$p ( r , z ; s ) \approx {\int }_{0}^{∞} {\sum }_{i = 1}^{N - 1} [ \frac{{\tilde{g}}_{i + 1} - {\tilde{g}}_{i}}{{k}_{{r}_{i + 1}} - {k}_{{r}_{i}}} ( {k}_{r} - {k}_{{r}_{i}} ) + {\tilde{g}}_{i} ] Π ( {k}_{{r}_{i}} , {r}_{{r}_{i + 1}} ) {J}_{0} ( {rk}_{r} ) {dk}_{r} . \qquad ( 8 )$$

After splitting the integral into sub-integrals from kᵣ_{ᵢ} to kᵣ_{ᵢ₊₁} and exchanging the order of summation and integration, (8) becomes

$$\begin{matrix}p ( r , z ; s ) \approx {\sum }_{i = 1}^{N - 1} {\int }_{{k}_{{r}_{i}}}^{{k}_{{r}_{i + 1}}} [ \frac{{\tilde{g}}_{i + 1} - {\tilde{g}}_{i}}{{k}_{{r}_{i + 1}} - {k}_{{r}_{i}}} ( {k}_{r} - {k}_{{r}_{i}} ) + {\tilde{g}}_{i} ] {J}_{0} ( {rk}_{r} ) {dk}_{r} \\ = {\sum }_{i = 1}^{N - 1} ( \frac{{\tilde{g}}_{i + 1} - {\tilde{g}}_{i}}{{k}_{{r}_{i + 1}} - {k}_{{r}_{i}}} ) {\int }_{{k}_{{r}_{i}}}^{{k}_{{r}_{i + 1}}} {k}_{r} {J}_{0} ( {rk}_{r} ) {dk}_{r} + \\ ( - \frac{{\tilde{g}}_{i + 1} - {\tilde{g}}_{i}}{{k}_{{r}_{i + 1}} - {k}_{{r}_{i}}} {k}_{{r}_{i}} + {\tilde{g}}_{i} ) {\int }_{{k}_{{r}_{i}}}^{{k}_{{r}_{i + 1}}} {k}_{r} {J}_{0} ( {rk}_{r} ) {dk}_{r} \\ = {\sum }_{i = 1}^{N - 1} ( \frac{{\tilde{g}}_{i + 1} - {\tilde{g}}_{i}}{{k}_{{r}_{i + 1}} - {k}_{{r}_{i}}} ) Δ {A}_{i} + \\ ( - \frac{{\tilde{g}}_{i + 1} - {\tilde{g}}_{i}}{{k}_{{r}_{i + 1}} - {k}_{{r}_{i}}} {k}_{{r}_{i}} + {\tilde{g}}_{i} ) Δ {B}_{i}\end{matrix} \qquad ( 9 )$$

$$where$$

$$Δ {A}_{i} = {\int }_{{k}_{{r}_{i}}}^{{k}_{{r}_{i + 1}}} {k}_{r} {J}_{0} ( {rk}_{r} ) {dk}_{r} = {\int }_{0}^{{k}_{{r}_{i + 1}}} {k}_{r} {J}_{0} ( {rk}_{r} ) {dk}_{r} - {\int }_{0}^{{k}_{{r}_{i}}} {k}_{r} {J}_{0} ( {rk}_{r} ) {dk}_{r} = {A}_{i + 1} - {A}_{i}$$

$$Δ {B}_{i} = {\int }_{{k}_{{r}_{i}}}^{{k}_{{r}_{i + 1}}} {J}_{0} ( {rk}_{r} ) {dk}_{r} = {\int }_{0}^{{k}_{{r}_{i + 1}}} {J}_{0} ( {rk}_{r} ) {dk}_{r} - {\int }_{0}^{{k}_{{r}_{i}}} {J}_{0} ( {rk}_{r} ) {dk}_{r} = {B}_{i + 1} - {B}_{i}$$

Aᵢ and Bᵢ are given b

$${A}_{i} = \frac{{k}_{{r}_{i}}}{r} {J}_{1} ( {rk}_{{r}_{i}} ) ,$$

$${B}_{i} = \frac{π {k}_{{r}_{i}}}{r} [ {J}_{0} ( {rk}_{{r}_{i}} ) ( \frac{2}{π} - {H}_{1} ( {rk}_{{r}_{i}} ) ) - {H}_{0} ( {rk}_{{r}_{i}} ) {J}_{- 1} ( {rk}_{{r}_{i}} ) ] .$$

The derivation can be found in the sections titled “Calculating Aᵢ in terms of J₁( )” and “Calculating Bᵢ in terms of Struve functions H₀( ) and H₁( )”. Calculating (6) for every offset r is a linear operation with respect to the field samples \tilde{g}ᵢ and can be conveniently implemented as a dot product. To see this, we rearrange the terms in (9):

$$p ( r , z ; s ) \approx {\sum }_{i = 1}^{N - 1} ( - \frac{Δ {A}_{i} - {k}_{{r}_{i}} Δ {B}_{i}}{{k}_{{r}_{i + 1}} - {k}_{{r}_{i}}} + Δ {B}_{i} ) {\tilde{g}}_{i} + \frac{Δ {A}_{i} - {k}_{{r}_{i}} Δ {B}_{i}}{{k}_{{r}_{i + 1}} - {k}_{{r}_{i}}} {\tilde{g}}_{i + 1} = ( - \frac{Δ {A}_{1} - {k}_{{r}_{2}} Δ {B}_{1}}{{k}_{{r}_{2}} - {k}_{{r}_{1}}} ) {\tilde{g}}_{1} + {\sum }_{i = 2}^{N - 1} ( \frac{Δ {A}_{i - 1} - {k}_{{r}_{i - 1}} Δ {B}_{i - 1}}{{k}_{{r}_{i}} - {k}_{{r}_{i - 1}}} - \frac{Δ {A}_{i} - {k}_{{r}_{i + 1}} Δ {B}_{i}}{{k}_{{r}_{i + 1}} - {k}_{{r}_{i}}} ) {\tilde{g}}_{i} + ( \frac{Δ {A}_{N - 1} - {k}_{{r}_{N - 1}} Δ {B}_{N - 1}}{Δ {k}_{{r}_{N - 1}}} ) {\tilde{g}}_{N} = {w}_{1} {\tilde{g}}_{1} + {\sum }_{i = 2}^{N - 1} {w}_{i} {\tilde{g}}_{i} + {w}_{N} {\tilde{g}}_{N} = {\sum }_{i = 1}^{N} {w}_{i} {\tilde{g}}_{i} . \qquad ( 10 )$$

Using (10) the inverse Hankel transform is evaluated at a single offset. By grouping multiple of these dot products as a matrix-vector product, the inverse transform can be evaluated for multiple offsets r in a single operation.

Calculating Aᵢ in terms of J₁( )

Using the change of variables

$$x = \frac{1}{{k}_{{r}_{i}}} {k}_{r}$$

and defining a=rkᵣ_{ᵢ}, we have

$${\int }_{0}^{{k}_{{r}_{i}}} {k}_{r} {J}_{0} ( r {k}_{r} ) d {k}_{r} = {k}_{{r}_{i}}^{2} {\int }_{0}^{1} x {J}_{0} ( a x ) d x .$$

Using 6.561-5 (p. 676) from Gradshteyn (2007),

$${\int }_{0}^{1} {x}^{v + 1} {J}_{v} ( a x ) d x = \frac{1}{a} {J}_{v + 1} ( a ) , Re \{ v \} > - 1 .$$

Setting v=0, it follows that

$${A}_{i} = {\int }_{0}^{{k}_{{r}_{i}}} {k}_{r} {J}_{0} ( r {k}_{r} ) d {k}_{r} = \frac{{k}_{{r}_{i}}^{2}}{a} {J}_{1} ( a ) = \frac{{k}_{{r}_{i}}}{r} {J}_{1} ( {rk}_{{r}_{i}} ) .$$

Calculating B₁ in Terms of Struve Functions H₀( ) and H₁( )

Using the change of variables

$$x = \frac{1}{{k}_{{r}_{i}}} {k}_{r}$$

and a=rkᵣ_{ᵢ}, we have that

$${\int }_{0}^{{k}_{{r}_{i}}} {J}_{0} ( {rk}_{r} ) d {k}_{r} = {k}_{{r}_{i}} {\int }_{0}^{1} {J}_{0} ( ax ) dx .$$

From Gradshteyn (2007) eq. 6.561-1 (p. 675),

$${\int }_{0}^{1} {x}^{v} {J}_{0} ( a x ) d x = {2}^{v - 1} {a}^{- v} {π}^{\frac{1}{2}} Γ ( v + \frac{1}{2} ) [ {J}_{v} ( a ) {H}_{v - 1} ( a ) - {H}_{v} ( a ) {J}_{v - 1} ( a ) ] ,$$

$$Re \{ v \} > - \frac{1}{2} ,$$

which for v=0 becomes

$${\int }_{0}^{1} {J}_{0} ( a x ) d x = \frac{\sqrt{π}}{2} Γ ( \frac{1}{2} ) [ {J}_{0} ( a ) {H}_{- 1} ( a ) - {H}_{0} ( a ) {J}_{- 1} ( a ) ] = \frac{π}{2} [ {J}_{0} ( a ) {H}_{- 1} ( a ) - {H}_{0} ( a ) {J}_{- 1} ( a ) ] , \qquad ( 12 )$$

using the fact that Γ(½)=\sqrt{π}. Therefore,

$${B}_{i} = {\int }_{0}^{{k}_{{r}_{i}}} {J}_{0} ( r {k}_{r} ) d {k}_{r} = \frac{π {k}_{{r}_{i}}}{2} [ {J}_{0} ( {rk}_{{r}_{i}} ) {H}_{- 1} ( {rk}_{{r}_{i}} ) - {H}_{0} ( {rk}_{{r}_{i}} ) {J}_{- 1} ( {rk}_{{r}_{i}} ) ] . \qquad ( 11 )$$

It is possible to modify (11) such that it is given in terms of H₁(x) rather than H₋₁(x). From Gradshteyn (2007) eq. 8.552-1 (p. 943), we have

$${H}_{n} ( x ) = \frac{1}{π} {\sum }_{m = 0}^{⌊ \frac{n - 1}{2} ⌋} \frac{Γ ( m + \frac{1}{2} ) {( \frac{x}{2} )}^{n - 2 m - 1}}{Γ ( n + \frac{1}{2} - m )} - {E}_{n} ( x ) , n = 1 , 2 , … ,$$

where Eᵥ( ) is the Weber function of order v. For n=1 and using Γ(3/2)=\sqrt{π}/2,

$${H}_{1} ( x ) = \frac{Γ ( \frac{1}{2} )}{π Γ ( \frac{3}{2} )} - {E}_{1} ( x ) = \frac{2}{π} - {E}_{1} ( x ) . \qquad ( 12 )$$

From Gradshteyn (2007) eq. 8.552-2 (p. 943) we have that

$${H}_{- n} ( x ) = {( - 1 )}^{n + 1} \frac{1}{π} {\sum }_{m = 0}^{⌊ \frac{n - 1}{2} ⌋} \frac{Γ ( n - m - \frac{1}{2} ) {( \frac{x}{2} )}^{- n + 2 m + 1}}{Γ ( m + \frac{3}{2} )} - {E}_{- n} ( x ) , \qquad ( 13 )$$

$$n = 1 , 2 , …$$

$$For n = 1 :$$

$${H}_{- 1} ( x ) = - {E}_{- 1} ( x ) .$$

We then use the following relationship between (Gradshteyn, 2007) eq. 8.582-4 (p. 948) is a useful relationship between Weber functions:

Eᵥ₋₁(x)+Eᵥ₊₁(x)=2vx⁻¹Eᵥ(x)−2(πx)⁻¹(1−cos(vπ)),

which for v=1 becomes

E₋₁(x)+E₁(x)=0. (14)

Equations (12), (13) and (14) form the system of linear equations

H₁(x)+E₁(x)=2/π

H₋₁(x)+E₋₁(x)=0

E₋₁(x)+E₁(x)=0.

Elimination of E₋₁(x) and E₁(x) yields

$${H}_{- 1} ( x ) = \frac{2}{π} - {H}_{1} ( x ) .$$

Plugging into (11), we get

$${B}_{i} = {\int }_{0}^{{k}_{{r}_{i}}} {J}_{0} ( r {k}_{r} ) d {k}_{r} = \frac{π {k}_{{r}_{i}}}{2} [ {J}_{0} ( {rk}_{{r}_{i}} ) ( \frac{2}{π} - {H}_{1} ( {rk}_{{r}_{i}} ) ) - {H}_{0} ( {rk}_{{r}_{i}} ) {J}_{- 1} ( {rk}_{{r}_{i}} ) ] .$$

At least part of the systems and methods described in this specification and their various modifications may be implemented or controlled, at least in part, by a computer program product, such as a computer program tangibly embodied in one or more information carriers, such as in one or more tangible machine-readable storage media, for execution by, or to control the operation of, data processing apparatus, for example a programmable processor, a computer, or multiple computers.

A computer program may be written in any form of programming language, including compiled or interpreted languages, and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a network.

Actions associated with implementing the systems may be performed by one or more programmable processors executing one or more computer programs to perform the functions of the calibration process. All or part of the systems may be implemented as special purpose logic circuitry, for example a field programmable gate array (FPGA) or an ASIC application-specific integrated circuit (ASIC), or both.

Processors suitable for the execution of a computer program include, by way of example, both general and special purpose microprocessors, and any one or more processors of any kind of digital computer. Generally, a processor will receive instructions and data from a read-only storage area or a random access storage area or both. Components of a computer (including a server) include one or more processors for executing instructions and one or more storage area devices for storing instructions and data. Generally, a computer will also include, or be operatively coupled to receive data from, or transfer data to, or both, one or more machine-readable storage media, such as mass storage devices for storing data, for example magnetic, magneto-optical disks, or optical disks. Non-transitory machine-readable storage media suitable for embodying computer program instructions and data include all forms of non-volatile storage area, including by way of example, semiconductor storage area devices, for example erasable programmable read-only memory (EPROM), electrically erasable programmable read-only memory (EEPROM), and flash storage area devices; magnetic disks, for example internal hard disks or removable disks; magneto-optical disks; and CD-ROM and DVD-ROM disks.

Each computing device, such as a surface-locating computing system, may include a hard drive for storing data and computer programs, and a processing device (for example a microprocessor) and memory (for example RAM) for executing computer programs. Each computing device may include an image capture device, such as a still camera or video camera. The image capture device may be built-in or simply accessible to the computing device.

Each computing device may include a graphics system, including a display screen. A display screen, such as a liquid crystal display (LCD) or a CRT (Cathode Ray Tube) displays, to a user, images that are generated by the graphics system of the computing device. As is well known, display on a computer display (for example a monitor) physically transforms the computer display. For example, if the computer display is LCD-based, the orientation of liquid crystals may be changed by the application of biasing voltages in a physical transformation that is visually apparent to the user. As another example, if the computer display is a CRT, the state of a fluorescent screen may be changed by the impact of electrons in a physical transformation that is also visually apparent. Each display screen may be touch-sensitive, allowing a user to enter information onto the display screen via a virtual keyboard. On some computing devices, such as a desktop or smartphone, a physical QWERTY keyboard or Arabic keyboard and scroll wheel may be provided for entering information onto the display screen. Each computing device, and computer programs executed on such a computing device, may also be configured to accept voice commands, and to perform functions in response to such commands. For example, the process described in this specification may be initiated at a client, to the extent possible, via voice commands.

Components of different implementations described in this specification may be combined to form other implementations not specifically set forth in this specification. Components may be left out of the systems, computer programs, databases, etc. described in this specification without adversely affecting their operation. In addition, the logic flows shown in, or implied by, the figures do not require the particular order shown, or sequential order, to achieve desirable results. Various separate components may be combined into one or more individual components to perform the functions described here.

### REFERENCES

Xu, P. C. and Mal, A. K. [1985]. An adaptive integration scheme for irregularly oscillatory functions. Wave Motion, 7(3), 235-243.
Krenk, S., Gerstoft, P. and Vilmann, O. [1989] Computational aspects of synthetic seismograms for layered media. 59th SEG Annual International Meeting, Expanded Abstracts, 1086-1089.
Georgiadis, H. G., Vamvatsikos, D., and Vardoulakis, I. [1999]. Numerical implementation of the integral-transform solution to Lamb's point-load problem. Computational mechanics, 24(2), 90-99.
Hai-Ming, Z. and Xiao-Fei, C. [2001]. Self-adaptive Filon's integration method and its application to computing synthetic seismograms. Chinese Physics Letters, 18(3), 313-315.
Gradshteyn, I. S. [2007] Table of integrals, series, and products (7th edition). Academic press.
Theodoulidis, T. [2015] On the closed-form expression of Carson's integral. Periodica Polytechnica Electrical Engineering and Computer Science, 59(1), 26-29.
Theodoulidis, T. (2019, Sep. 24) Struve functions. Retrieved from Matlab Central: https://nl.mathworks.com/matlabcentral/fileexchange/37302-struve-functions.
Tripathi, M. P. [2014] Stable numerical evaluation of the finite Hankel transforms and their application. International Journal of Analysis, 2014, 1-11.

1. A method for producing a seismic wave velocity model of a subsurface area, the method comprising:
receiving, by a processor of a computing system, from a seismic receiver, seismic data input comprising a recorded seismic wave field;
receiving, by the processor, an initial 1D velocity model of the subsurface area;
receiving, by the processor, data input comprising a maximum misfit value and maximum iteration value;
determining, by the processor, a Laplace-Fourier transform of the recorded seismic wave field;
setting, by the processor, a current 1D velocity model to the initial 1D velocity model;
setting, by the processor, an iteration value n to zero;
regenerating, by the processor, the current 1D velocity model to generate inverted data representing the subsurface area by:
(i) generating, by the processor, a modeled synthetic wave field in the Laplace-Fourier domain using the current 1D velocity model;
(ii) comparing the modeled synthetic wave field with the recorded seismic wave field to determine a misfit value;
(iii) if the determined misfit value is less than the maximum misfit value, outputting the current 1D velocity model as the final 1D velocity model;
(iv) if the determined misfit value is greater than the maximum misfit value, and if the iteration value is equal to or greater than the maximum iteration value, outputting the current 1D velocity model as the final velocity model; and
(v) if the determined misfit value is greater than the maximum misfit value, and if the iteration value is less than the maximum iteration value, generating a corrected current 1D velocity model using a gradient of a misfit function and setting the iteration value to n+1, and repeating steps (i) through (v).

2. The method of claim 1, comprising performing, by the processor, an upscaling of a plurality of 1D velocity models to produce a 3D velocity model.

3. The method of claim 1, where generating a modeled synthetic wave field in the Laplace-Fourier domain comprises calculating an inverse Hankel transformation integral using an iterative horizontal wavenumber line segmentation process to determine locations for sampling the integrand and the upper limit at which to truncate the transformation integral.

4. The method of claim 3, where the segmentation process comprises determining an end to a segment using the Newton-Raphson method.

5. The method of claim 1, where generating a modeled synthetic wave field in the Laplace-Fourier domain comprises calculating an inverse Hankel transformation using an adaptive sampling technique to determine horizontal wavenumbers to be sampled in a segment.

6. The method of claim 5, where the adaptive sampling technique comprises iteratively splitting the segment into two or more intervals of equal or unequal length.

7. The method of claim 5, where the adaptive sampling technique comprises determining convergence at two or more points in each segment.

8. The method of claim 1, comprising generating, by the processor, a seismic image of the subsurface area using the inverted data.

9. One or more non-transitory machine-readable storage media storing instructions for producing a seismic wave velocity model of a subsurface area, the instructions being executable by one or more processing devices to perform operations comprising:
receiving, from a seismic receiver, seismic data input comprising a recorded seismic wave field;
receiving, an initial 1D velocity model of the subsurface area;
receiving, data input comprising a maximum misfit value and maximum iteration value;
determining, a Laplace-Fourier transform of the recorded seismic wave field;
setting, a current 1D velocity model to the initial 1D velocity model;
setting, an iteration value n to zero;
regenerating, the current 1D velocity model to generate inverted data representing the subsurface area by:
(i) generating, a modeled synthetic wave field in the Laplace-Fourier domain using the current 1D velocity model;
(ii) comparing the modeled synthetic wave field with the recorded seismic wave field to determine a misfit value;
(iii) if the determined misfit value is less than the maximum misfit value, outputting the current 1D velocity model as the final 1D velocity model;
(iv) if the determined misfit value is greater than the maximum misfit value, and if the iteration value is equal to or greater than the maximum iteration value, outputting the current 1D velocity model as the final velocity model; and
(v) if the determined misfit value is greater than the maximum misfit value, and if the iteration value is less than the maximum iteration value, generating a corrected current 1D velocity model using a gradient of a misfit function and setting the iteration value to n+1, and repeating steps (i) through (v).

10. The one or more non-transitory machine-readable storage media of claim 9, where the operations comprise performing an upscaling of a plurality of 1D velocity models to produce a 3D velocity model.

11. The one or more non-transitory machine-readable storage media of claim 9, where generating a modeled synthetic wave field in the Laplace-Fourier domain comprises calculating an inverse Hankel transformation integral using an iterative horizontal wavenumber line segmentation process to determine locations for sampling the integrand and the upper limit at which to truncate the transformation integral.

12. The one or more non-transitory machine-readable storage media of claim 11, where the segmentation process comprises determining an end to a segment using the Newton-Raphson method.

13. The one or more non-transitory machine-readable storage media of claim 9, where generating a modeled synthetic wave field in the Laplace-Fourier domain comprises calculating an inverse Hankel transformation using an adaptive sampling technique to determine horizontal wavenumbers to be sampled in a segment.

14. The one or more non-transitory machine-readable storage media of claim 13, where the adaptive sampling technique comprises iteratively splitting the segment into two or more intervals of equal or unequal length.

15. The one or more non-transitory machine-readable storage media of claim 13, where the adaptive sampling technique comprises determining convergence at two or more points in each segment.

16. The one or more non-transitory machine-readable storage media of claim 9, where the operations comprise generating, by the processor, a seismic image of the subsurface area using the inverted data.

17. A system comprising:
one or more non-transitory machine-readable storage media storing instructions for producing a seismic wave velocity model of a subsurface area, and
one or more processing devices to execute the instructions to perform operations comprising:
receiving, by a processor of a computing system, from a seismic receiver, seismic data input comprising a recorded seismic wave field;
receiving, by the processor, an initial 1D velocity model of the subsurface area;
receiving, by the processor, data input comprising a maximum misfit value and maximum iteration value;
determining, by the processor, a Laplace-Fourier transform of the recorded seismic wave field;
setting, by the processor, a current 1D velocity model to the initial 1D velocity model;
setting, by the processor, an iteration value n to zero;
regenerating, by the processor, the current 1D velocity model to generate inverted data representing the subsurface area by:
(i) generating, by the processor, a modeled synthetic wave field in the Laplace-Fourier domain using the current 1D velocity model;
(ii) comparing the modeled synthetic wave field with the recorded seismic wave field to determine a misfit value;
(iii) if the determined misfit value is less than the maximum misfit value, outputting the current 1D velocity model as the final 1D velocity model;
(iv) if the determined misfit value is greater than the maximum misfit value, and if the iteration value is equal to or greater than the maximum iteration value, outputting the current 1D velocity model as the final velocity model; and
(v) if the determined misfit value is greater than the maximum misfit value, and if the iteration value is less than the maximum iteration value, generating a corrected current 1D velocity model using a gradient of a misfit function and setting the iteration value to n+1, and repeating steps (i) through (v).

18. The system of claim 17, where the operations comprise performing an upscaling of a plurality of 1D velocity models to produce a 3D velocity model.

19. The system of claim 17, where generating a modeled synthetic wave field in the Laplace-Fourier domain comprises calculating an inverse Hankel transformation integral using an iterative horizontal wavenumber line segmentation process to determine locations for sampling the integrand and the upper limit at which to truncate the transformation integral.

20. The system of claim 19, where the segmentation process comprises determining an end to a segment using the Newton-Raphson method.

21. The system of claim 17, where generating a modeled synthetic wave field in the Laplace-Fourier domain comprises calculating an inverse Hankel transformation using an adaptive sampling technique to determine horizontal wavenumbers to be sampled in a segment.

22. The system of claim 21, where the adaptive sampling technique comprises iteratively splitting the segment into two or more intervals of equal or unequal length.

23. The system of claim 21, where the adaptive sampling technique comprises determining convergence at two or more points in each segment.

24. The system of claim 17, where the operations comprise generating, by the processor, a seismic image of the subsurface area using the inverted data.
